(19) United States
(12) Patent Application Publication
(10) Pub. No.: US 2019/0040647 A1
(43) Pub. Date: Feb. 7, 2019

(54) Azimuth Adjustable Tilt-Tower System

(71) Applicants: Jaime Timian, Levelland, TX (US); Charles A. Anderson, San Angelo, TX (US); Sean P. Gallagher, San Angelo, TX (US)

(72) Inventors: Jaime Timian, Levelland, TX (US); Charles A. Anderson, San Angelo, TX (US); Sean P. Gallagher, San Angelo, TX (US)

(21) Appl. No.: 15/940,735

(22) Filed: Mar. 29, 2018

Related U.S. Application Data
(60) Provisional application No. 62/478,415, filed on Mar. 29, 2017.

(51) Int. Cl. E04H 12/34; H01Q 1/08

(52) U.S. Cl. CPC E04H 12/345; B66D 1/60; B66D 2700/0183; H01Q 1/084

(57) ABSTRACT

Azimuth adjustable tilt-towers may be provided by a variety of systems, processes, and techniques. In certain embodiments, a tilt tower may include a tilt tube having a near end and a removed end and a pivot about which the removed end of the tilt tube pivots from an upright orientation to a ground level orientation. The tower may also include an elongated mounting tube and a thrust bearing. The mounting tube may extend through and protrude from the ends of the tilt tube and have a near end and a removed end. The thrust bearing may be located near the removed end of the tilt tube and configured to axially support the mounting tube while allowing it to rotate such that the mounting tube may be rotated about its longitudinal axis by access to the near end while the removed end of the tilt tube is in the upright position.

### RELATED APPLICATIONS

This application claims priority to and the benefit of U.S. Patent Application No. 62/478,415, entitled “Azimuth Directable Tilt-Tower” and filed Mar. 29, 2017. This prior application is herein incorporated by reference in its entirety. Also incorporated herein by reference are U.S. Pat. Nos. 9,650,802, 8,863,450, and 8,800,219.

### FIELD OF THE INVENTION

This disclosure relates to tilt-tower systems, and more specifically, to tilt-tower systems configured to have the azimuth of their antenna adjusted while the tower in the vertical orientation.

### BACKGROUND OF THE INVENTION

Antennas for receiving and transmitting electromagnetic wave communications are often provided on elevated towers for more efficient receiving and transmitting, such as communication in the 160 MHz to 960 MHz range. As the antennas themselves are mounted typically far off the ground, they are by their position inaccessible. Thus, installing, replacing, repairing, and/or maintaining these antennas may be difficult.

Some antenna towers provide for a swing-tube mechanism for bringing the antenna close to the ground. By this functionality, the antenna itself is able to be reached by the serviceman. Antenna towers of this type are sometimes referred to as “tilt towers.”

Antenna tilt towers are known in the art for mounting an antenna to the removed end of a tower. Tilt towers allow a serviceman access to the antenna by removing a coupling and allowing a tilt or swing tube section of the antenna to rotate about the removed end of the mast or base tube from an antenna up (skyward) position to an antenna down (adjacent the ground) position, providing access to the serviceman.

### SUMMARY

Various embodiments of tilt-tower systems that allow the azimuth of an antenna mounted thereon to be adjusted while the tower is in the upright orientation are disclosed. In particular implementations, a tower assembly may include a tilt tube having a near end and a removed end and a pivot about which the removed end of the tilt tube pivots from an upright orientation to a ground-level orientation. The tower assembly may also include an elongated mounting tube and a thrust bearing. The mounting tube may extend through and protrude from the ends of the tilt tube and have a near end and a removed end. In some implementations, the tilt tube is at least eighty percent of the length of the mounting tube. The removed end of the mounting tube may be configured to allow a communication antenna to be mounted thereto. The thrust bearing may be located near the removed end of the tilt tube and is configured to axially support the mounting tube while allowing it to rotate such that the mounting tube may be rotated about its longitudinal axis while the removed end of the tilt tube is in the upright position.

In certain implementations, the tower assembly may also include a grasping mechanism coupled to the near end of the tilt tube. The grasping mechanism may be adapted to selectively engage the mounting tube to prevent it from rotating around its longitudinal axis. The grasping member may, for example, include a sleeve configured to surround the mounting tube. The sleeve may include a number of radial apertures that allow a number of screws to penetrate the sleeve and engage the mounting tube. In some implementations, the grasping mechanism may be coupled between the mounting tube and a base beam.

In certain implementations, the thrust bearing is located on top of the tilt tube. Additionally, the mounting tube may include a bearing plate near its removed end. The bearing plate may be adapted to engage the thrust bearing. In some implementations, the thrust bearing may allow the mounting tube to be rotated by hand when the pivot tube is in the upright position. The thrust bearing may also allow the mounting tube to move longitudinally relative to the tilt tube.

The tilt-tower system may also include a base beam adapted to support the pivot. The base beam may include an elongated cavity configured such that the near end of the tilt tube may fit at least partially within the cavity. In some implementations, the base beam may include a cover pivotably coupled to the base beam. The cover may be adapted to surround the near end of the mounting tube when the removed end is in the upright position.

In certain implementations, the tilt-tower system may include a radial bracket coupled to the near end of the mounting tube. The raid bracket may be configured to prevent the near end of the mounting tube from sliding into the tilt tube.

The disclosed tilt-tower systems have a variety of features. For example, by extending through the tilt tube, a mounting tube may allow the azimuth of the antenna to be adjusted while the tilt tube is in a vertical orientation. This allows the positioning of the antenna to be adjusted while in its vertical operating position, which should provide for enhanced antenna performance. As another example, the antenna may be brought to ground level for service, repair, and replacement. As an additional example, the adjustment features for the antenna positioning may be protected from tampering. Various combinations of features may be achieved in various implementations. Other features will be apparent to those skilled in the art from reviewing the following written description, figures, and claims.

### BRIEF DESCRIPTION OF THE DRAWINGS

FIGS. 1A and 1B illustrate front and side views of an example azimuth adjustable tilt-tower system in an upright orientation.

FIG. 2 illustrates a detailed view of an example engagement between a mounting tube and a tilt tube at top of the tilt tube.

FIGS. 2A and 2B illustrate an example engagement of a thrust bearing cap and a tilt tube.

FIGS. 3 and 3A illustrate a detailed view of an example engagement between a mounting tube and a tilt tube at the bottom of the tilt tube.

FIGS. 4A and 4B illustrate side and top views of the tilt-tower system in a tilted-down orientation.

FIG. 5 illustrates an example antenna for mounting on the tilt-tower system.

FIGS. 6A, 6B, and 6C illustrate another example azimuth adjustable tilt-tower system.

FIG. 7 illustrates a detailed view of an example engagement between a base beam, a tilt tube, and a mounting tube.

FIGS. 8A and 8B illustrate a detailed view of an example engagement between the lower end of a mounting tube and a base beam.

FIGS. 9A and 9B illustrate an additional example azimuth adjustable tilt-tower system.

FIG. 10 illustrates a detailed view of an example engagement between a mounting tube and a tilt tube at top of the tilt tube.

FIG. 11 illustrates an example engagement between a tilt tube and a base beam.

FIGS. 12A and 12B illustrate an example engagement between a base beam, the lower end of a tilt tube, and the lower end of a mounting tube.

### DETAILED DESCRIPTION OF EXAMPLE EMBODIMENTS

FIGS. 1A and 1B illustrate an example tilt-tower system 10 for supporting a communication antenna. (not shown here to improve clarity). The communication antenna may, for example, be a dish, a dipole, or a directional antenna. Tilt towers and details of their construction may be found in U.S. Pat. Nos. 9,650,802, 8,863,450 and 8,800,219, which are herein incorporated by reference. Typically, the communication antenna is provided at or near the removed end of the tower system so that the antenna may more readily communicate (send and/or receive) to and from a remote location. For example, tower-mounted communication antennas may be used for railroad applications (e.g., Positive Train Control), petroleum industry applications, weather reporting applications, solar panel installations, and a variety other applications that require wireless radio communications. Typical antennas weigh between 2-50 lbs, but other sizes may be used depending on application.

Tower system 10 includes a base beam 11 having a near end 12a and a removed end 12b. Near end 12a may include a baseplate 13, for example, a 0.75 inch metal plate, which may be coupled to an anchor (not shown). The anchor may have been previously inserted into the ground. The anchor may, for example, include an auger-type shaft or a concrete block.

Tower system 10 also includes a tilt tube 14 and a mounting tube 16. Tilt tube 14 includes a removed end 15a and a near end 15b. Near end 15b of tilt tube 14 is received at least partially in base beam 11 in the illustrated implementation when tilt tube 14 is in the upright position. Base beam 11 may have a U-shape to receive near end 15b of tilt tube 14, a cut-out, or any other approximate configuration. In other implementations, tilt tube 14 is not received in base beam 11.

Mounting tube 16 also includes a removed end 17a and a near end 17b and extends through tilt tube 14, with removed end 17a protruding from removed end 15a of the tilt tube and near end 17b protruding from near end 15b of the tilt tube. The antenna may, for example, be mounted on removed end 17a of the mounting tube 16. In particular implementations, mounting tube 16 is hollow. In certain implementations, one or more portions of mounting tube 16 could be solid (e.g., the removed end).

Tilt tube 14 is coupled to base beam 11 at a pivot 18. Pivot 18 allows removed end 15a of tilt tube 14 to be raised and lowered (e.g., by being rotated in a vertical plane). In the lowered position, an antenna may be coupled to removed end 17a of mounting tube 16 and/or serviced. In the raised position, the antenna may perform its communication functions.

By extending through tilt tube 14, mounting tube 16 allows the azimuth of the antenna to be adjusted. This may be especially useful while tilt tube 14 is in a vertical orientation. Although the antennas on towers are fairly static in operation, they typically must be adjusted from time to time (e.g., as the network configuration changes).

FIGS. 2, 2A, and 2B illustrate an example coupling of mounting tube 16 to tilt tube 14 at removed end 15a of the tilt tube. As illustrated, a top cap 20a is mounted onto removed end 15a of tilt tube 14. In the illustrated implementation, the mounting is achieved by bolts 21 that clamp top cap 20a onto the outer surface of tilt tube 14. Other fastening techniques (e.g., welding) may be used in other implementations. On top of top cap 20a is a thrust bearing 22, which may, for example, be uncoupled from top cap 20a. Thrust bearing 22 axially supports mounting tube 16 while allowing it to rotate. Thrust bearing 22 may be composed of metal, polymer, or any other appropriate type of material and may have a needle, roller, or other appropriate configuration. Furthermore, thrust bearing 22 may be lubricated or unlubricated. Examples of thrust bearing 22 appear in FIG. 2A and FIG. 2B.

Mounting tube 16 includes a bearing plate 24 that sits on top of thrust bearing 22, a gap being illustrated here between bearing plate 24 and thrust bearing 22 to improve clarity, although there may be some longitudinal movement in mounting tube at some points of operation. In the illustrated implementation, bearing plate 24 is welded to mounting tube 16, but other fastening techniques may be used in other implementations. Longitudinal movement of mounting tube 16 may be minimized in some embodiments by using a collar around mounting tube 16.

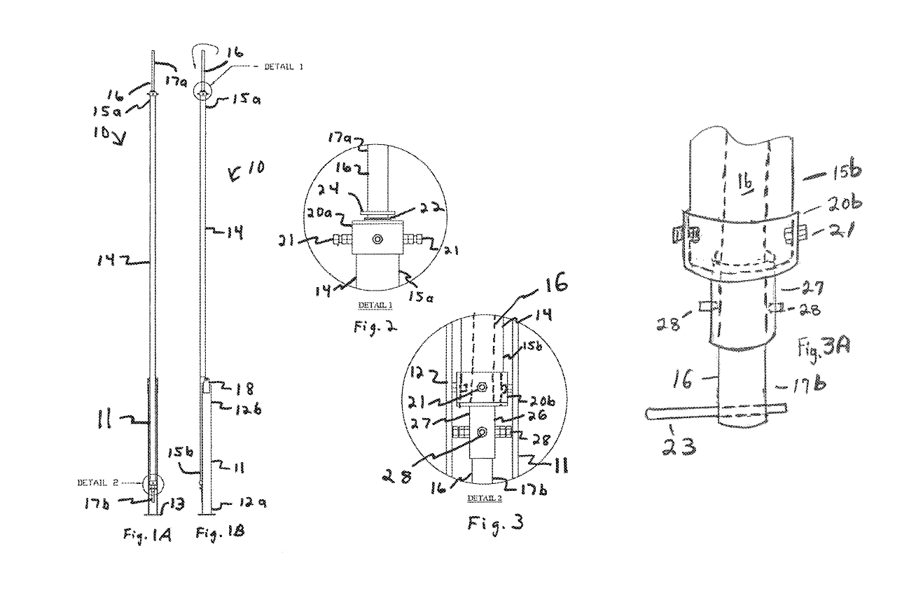

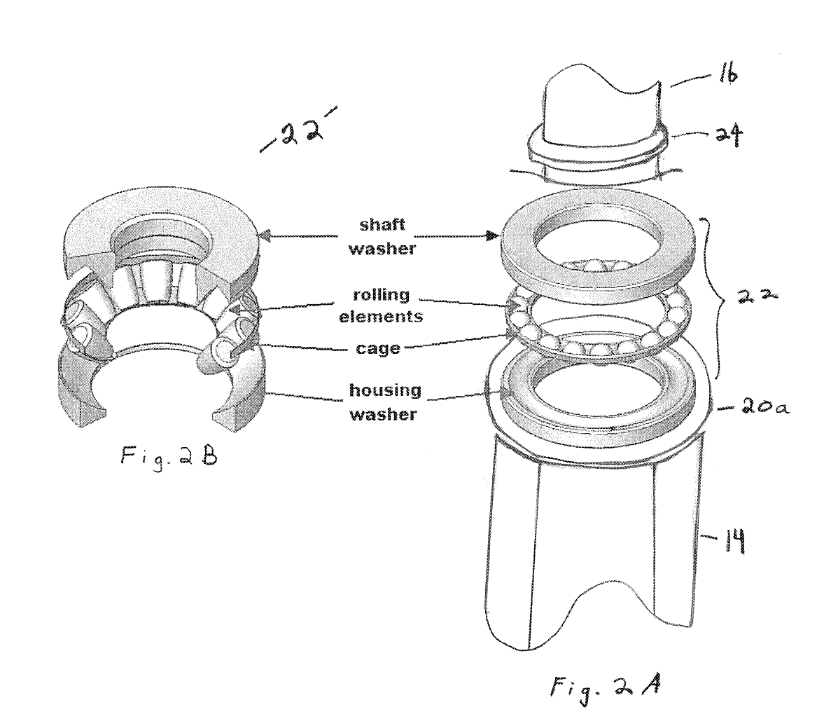

FIGS. 3 and 3A illustrate an example coupling of mounting tube 16 to tilt tube 14 at near end 15b of tilt tube 14. As illustrated, a cap 20b is mounted onto near end 15b of tilt tube 14. In the illustrated implementation, the mounting is achieved by bolts 21 that clamp cap 20b onto tilt tube 14. Other fastening techniques (e.g., welding) may be used in other implementations.

Coupled to the bottom of cap 20b is a grasping mechanism 26. Grasping mechanism 26 includes a sleeve 27 and sleeve-mounted set screws 28. Sleeve 27 is coupled to cap 20b (e.g., by welding). Sleeve 27 axially aligns mounting tube 16 while allowing it to rotate about its longitudinal axis. Sleeve 27 includes a number of apertures (not visible in these views) through which set screws 28 may be inserted. Set screws 28 clamp onto the outer surface of mounting tube 16 to secure it against rotation about its longitudinal axis. The set screws may also prevent mounting tube 16 from translating longitudinally. In the illustrated implementation, sleeve 27 includes four apertures through which set screws may be inserted. In other implementations, a different number of apertures may be used (e.g., three or five). In general, a grasping mechanism may be any device that can selectively engage mounting tube 16 to prevent it from rotating (e.g., a clamp or a bracket.

In operation, the azimuth of removed end 17a of mounting tube 16, and, by consequence, that of an antenna, may be adjusted by loosening set screws 28 in sleeve 27 and grasping and turning near end 17b of mounting tube 16. Because thrust bearing 22 is carrying the weight of mounting tube 16, this adjustment may be performed without the aid of a machine in particular implementations (e.g., by hand). In certain implementations, mounting tube 16 may have an L-shaped bracket connected thereto by U-bolts and extending out to a radius plate that creates a handle to turn the tube. In some implementations, the adjustment may be performed with the assistance of a hand tool (e.g., a vise-grip). Other implementations may use a bar 23 inserted in holes at near end 17b for leverage to rotate mounting tube as shown in FIG. 3A. The azimuth of removed end 17a may be adjusted to the appropriate angle, and then the set screws 28 may be retightened. Additionally, being able to adjust the azimuth may be useful when servicing the antenna (e.g., when removed end 15a of tilt tube 14 has been pivoted close to the ground).

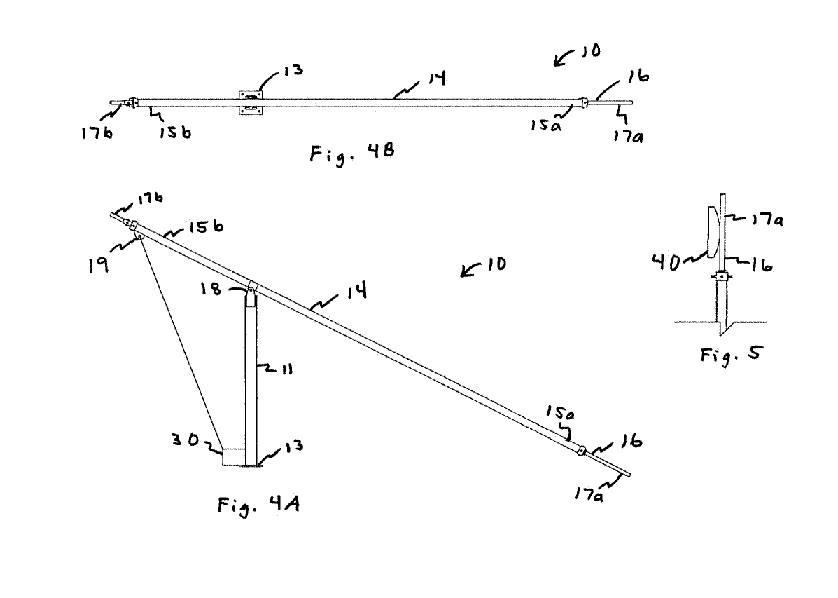

FIGS. 4A and 4B illustrate tower system 10 in the ground-accessible position. As can be seen best in FIG. 4A, removed end 15a of tilt tube 14 has been rotated around pivot 18 to bring removed end 17a of mounting tube 16 close to the ground. This will allow for servicing of the antenna or installation of a new antenna. Additionally, the azimuth of mounting tube 16, and hence the antenna, may be adjusted at this time. Mounting tube 16 prevented from sliding out of swing tube 14 by set screws 28.

Tilt tube 14 also includes a cable mount 19 to which a cable may be mounted for use in raising and lower tilt tube 14. In this implementation, cable mount 19 is a tab that is welded onto the outside of tilt tube 14. Cable mount 19 may have other configurations in other implementations (e.g., a bracket secured around tilt tube 14).

In the illustrated configuration, tower system 10 is approximately 40 ft tall. Thus, a winch 30 (e.g., AC or DC powered or manual) may be used in lowering and/or raising tilt tube 14. Winch 30 may be removed when tilt tube 14 is in the upright orientation. In particular implementations, a truck-mounted winch may be used.

The components of tower system 10 may be made of a variety of materials. For example, base beam 11, pivot tube 18, and mounting tube 16 may be made of steel, aluminum, carbon fiber, or any other appropriate material. In the illustrated implementation, tower system 10 is approximately 40 ft. tall, and pivot 18 is approximately 11 ft. off the ground. Different heights of towers, types of components, and ratios between components may be used for different applications, however. Moreover, the thrust bearing may be located at the bottom instead of the top of tilt tube 14 or therebetween, or multiple thrust bearings may be used or in both places.

FIG. 5 illustrates an example antenna 40 for mounting on tilt-tower system 10. As seen in this example, antenna 40 is mounted to removed end 17a of mounting tube 16.

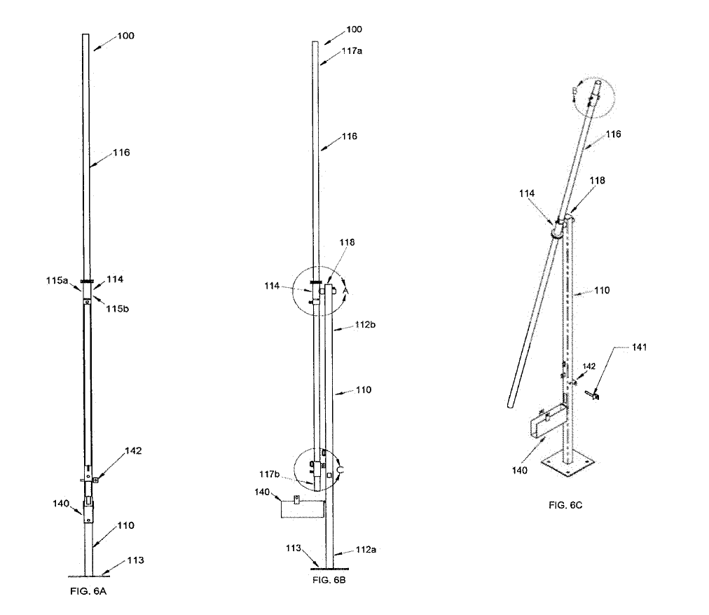

FIGS. 6A, 6B, and 6C illustrate another example tilt-tower system 100 for supporting a communication antenna (not shown here to improve clarity). The communication antenna may, for example, be a dish, a dipole, or a directional antenna. As before, the communication antenna is typically provided at or near the removed end of the tower system so that the antenna may more readily communicate (send and/or receive) to and from a remote location.

Tower system 100 includes a base beam 110 having a near end 112a and a removed end 112b. Near end 112a may include a baseplate 113, for example, a 0.75 inch metal plate, which may be coupled to an anchor (not shown). The anchor may have been previously inserted into the ground. The anchor may, for example, include an auger-type shaft or a concrete block. Base beam 110 may, for example, be a circular tube in this implementation.

Tower system 100 also includes a tilt tube 114 and a mounting tube 116. Tilt tube 114 includes a removed end 115a and a near end 115b. Near end 115b of tilt tube 114 is received at the side of base beam 110 in the illustrated implementation when tilt tube 114 is in the upright position. In other implementations, at least part of near end 1156 may be received in base beam 110.

Mounting tube 116 also includes a removed end 117a and a near end 117b and extends through tilt tube 114, with removed end 117a protruding from removed end 115a of the tilt tube and near end 117b protruding from near end 115b of the tilt tube. The antenna may, for example, be mounted on removed end 117a of mounting tube 116. In the illustrated implementation, mounting tube 116 is hollow. In certain implementations, one or more portions of mounting tube 16 could be solid (e.g., the removed end). Base beam 110 may have a cavity (e.g., a U-shape or a cut-out) to receive near end 117b of mounting tube 116.

Tilt tube 114 is coupled to base beam 110 at a pivot 118. Pivot 118 allows removed end 117a of mounting tube 116 to be raised and lowered (e.g., by rotating in a vertical plane). In the lowered position, an antenna may be coupled to removed end 117a of mounting tube 116 and/or serviced. In the raised position, the antenna may perform its communication functions.

By extending through tilt tube 114, mounting tube 116 allows the azimuth of the antenna to be adjusted. This may be especially useful while tilt tube 114 is in a vertical orientation.

Base beam 110 also includes a cover 140 pivotably mounted thereto. When mounting tube 116 is in the operating orientation (i.e., upright), near end 117b of mounting tube 116 may be partially surrounded by cover 140 to protect mounting tube from unauthorized adjustment. In this implementation, cover 140 is secured to base beam 110 by a pin 141 that is inserted through apertures in cover 140 and in base beam 110. Pin 141 may then be locked (e.g., via a padlock) to base beam 110 via a tab 142 coupled thereto.

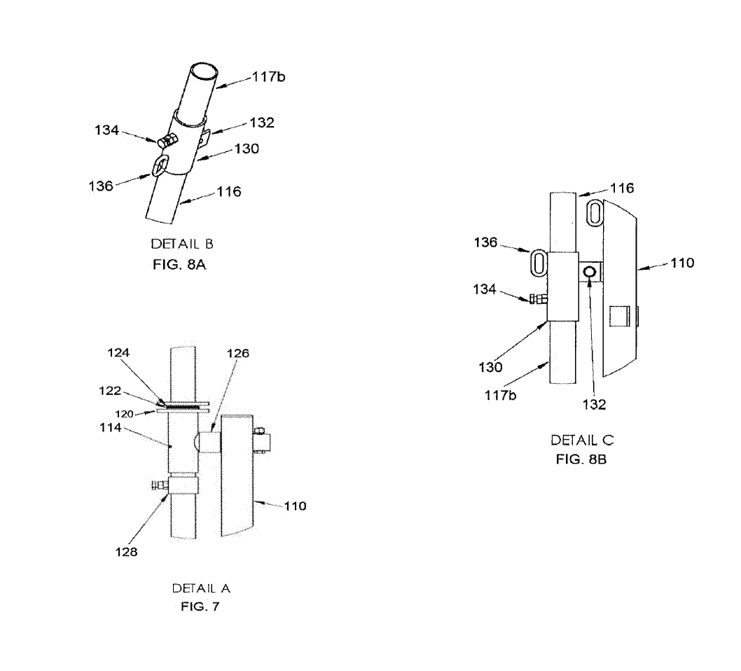

FIG. 7 illustrates an example coupling of mounting tube 116 to tilt tube 114 and tilt tube 114 to base beam 110. As illustrated, removed end 115a of tilt tube 114 includes a flange plate 120 mounted thereto. In the illustrated implementation, the mounting is achieved by welding. Other fastening techniques may be used in other implementations. On top of flange plate 120 is a thrust bearing 122, which may, for example, be uncoupled from flange plate 120. Thrust bearing 122 axially supports mounting tube 116 while allowing it to rotate. Thrust bearing 122 may be composed of metal, polymer, or any other appropriate type of material and may have a needle, roller, or other appropriate configuration. Furthermore, thrust bearing 120 may be lubricated or unlubricated.

Mounting tube 116 includes a bearing plate 124 that sits on top of thrust bearing 122. Thrust bearing 122 allows some axial movement between trust bearing 122 and bearing plate 124 at some points of operation. In the illustrated implementation, bearing plate 124 is welded to mounting tube 116, but other fastening techniques may be used in other implementations.

As best seen in this figure, swing tube 114 includes a pivot collar 126 attached thereto. Pivot collar 126 extends through an aperture in base beam 110 (not visible) to allow swing tube to rotate. Pivot collar may be secured to base beam 110 by various devices (e.g. a bolt, washer, lock washer, and nut combination). Pivot collar 126 may be greased.

Mounting tube 116 also includes a collar 128 mounted thereto. Collar 128 prevents mounting tube 116 from sliding through swing tube 114 (e.g., when removed end 117b is in a downward position). Collar 128 may be secured by various devices (e.g., a bolt and nut combination).

FIGS. 8A-8B illustrate the coupling between near end 117b of mounting tube 116 and base beam 110. As illustrated, mounting tube 116 has a sleeve 130 mounted thereto. Sleeve 130 includes a securing tab 132, a set screw 134, and a line tab 136, sleeve 130 and set screw 134 being one example of a grasping mechanism. Base beam also 110 includes a tab (not visible here) that is similar to securing tab 132 so that when securing tab 132 is brought near to the tab on the base beam, the two tabs may be secured together (e.g., by a bolt, washer, lock washer, and nut combination). Set screw 134 is adapted to engage mounting tube 116 to secure it from rotating about its longitudinal axis or translating therealong. Line tab 136 allows a line (e.g., a cable or rope) to be secured near near end 116b to rotate mounting tube 116 from the ground-accessible position to the upright position.

When near end 117b of mounting tube 116 has been secured by securing tab 132 of sleeve 130, cover 140 may be pivoted over near end 117b so that it at least partially surrounds securing tab 132 and set screw 134, to prevent tampering with mounting tube 116. In this implementation, cover 140 has no top. Thus, it only partially surrounds receiving tab 132 and set screw 134. In other implementations, it may fully surround them.

In operation, the azimuth of removed end 117a of mounting tube 116, and, by consequence, that of an antenna, may be adjusted by loosening set screw 134 in sleeve 130 and grasping and turning near end 117b of mounting tube 116. Because thrust bearing 122 is carrying the weight of mounting tube 116, this adjustment may be performed without the aid of a machine in particular implementations (e.g., by hand). In certain implementations, mounting tube 16 may have an L-shaped bracket connected thereto by U-bolts and extending out to a radius plate that creates a handle to turn the tube. In some implementations, the adjustment may be performed with the assistance of a hand tool (e.g., a vise-grip). Another implementation may use a bar inserted in holes at near end 117b for leverage to rotate mounting tube 116. The azimuth of removed end 117a may be adjusted to the appropriate angle, and set screw 134 may be retightened. Additionally, being able to adjust the azimuth may be useful when servicing the antenna (e.g., when removed end 117a of tilt mounting tube 116 has been pivoted close to the ground).

The components of tower system 100 may be made of a variety of materials. For example, base beam 110, pivot tube 114, and mounting tube 116 may be made of steel, aluminum, carbon fiber, or any other appropriate material. In the illustrated implementation, tower system 100 is approximately 20 ft tall, and pivot 15 is approximately 10 ft off the ground. Different heights of towers, types of components, and ratios between components may be used for different applications, however. Moreover, the thrust bearing may be located at the bottom instead of the top of tilt tube 14 therebetween, or there may be multiple thrust bearings.

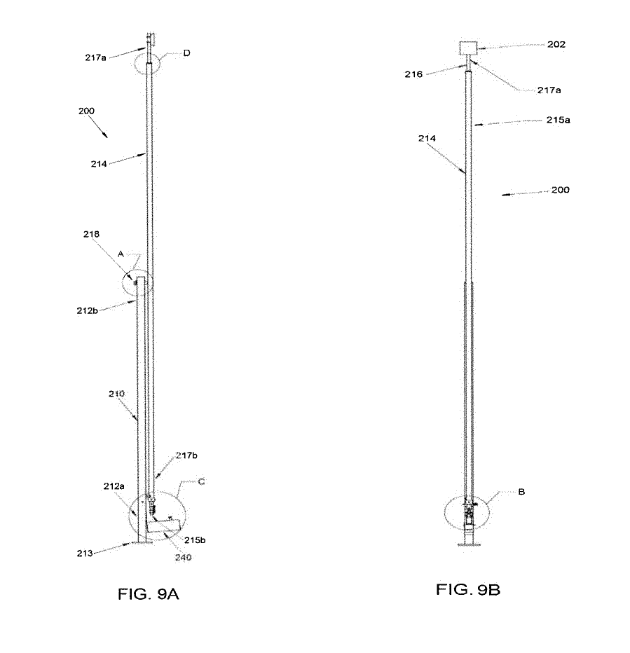

FIGS. 9A and 9B illustrate an additional example tilt-tower system 200 for supporting a communication antenna, an example of which is shown here as a dipole antenna 202. As before, the communication antenna is typically provided at or near the removed end of the tower system so that the antenna may more readily communicate (send and/or receive) to and from a remote location.

Tower system 200 includes a base beam 210 having a near end 212a and a removed end 212b. Near end 212a may include a baseplate 213, for example, a 0.75 inch metal plate, which may be coupled to an anchor (not shown). The anchor may have been previously inserted into the ground. The anchor may, for example, include an auger-type shaft or a concrete block.

Tower system 200 also includes a tilt tube 214 and a mounting tube 216. Tilt tube 214 includes a removed end 215a and a near end 215b. Near end 215b of tilt tube 214 is received at the side of base beam 210 in the illustrated implementation when tilt tube 214 is in the upright position. In other implementations, base beam 110 may have a cavity (e.g., a U-shape or a cut-out) to receive near end 215b of tilt tube 214.

Mounting tube 216 also includes a removed end 217a and a near end 217b and extends through tilt tube 214, with removed end 217a protruding from removed end 215a of the tilt tube and near end 217b protruding from near end 215b of the tilt tube. Antenna 202 is mounted on removed end 217a of mounting tube 216. In the illustrated implementation, mounting tube 216 is hollow. In certain implementations, one or more portions of mounting tube 216 could be solid (e.g., the removed end).

Tilt tube 214 is coupled to base beam 210 at a pivot 218. Pivot 218 allows removed end 215a of tilt tube 216 to be raised and lowered (e.g., by rotating in a vertical plane). In the lowered position, an antenna may be coupled to removed end 217a of mounting tube 216 and/or serviced. In the raised position, the antenna may perform its communication functions.

By extending through tilt tube 214, mounting tube 216 allows the azimuth of antenna 202 to be adjusted. This may be especially useful while tilt tube 214 is in a vertical orientation.

FIG. 10 illustrates an example coupling of mounting tube 216 to tilt tube 214. As illustrated, removed end 215a of tilt tube 214 includes a flange plate 220 mounted thereto. In the illustrated implementation, the mounting is achieved by welding. Other fastening techniques be used in other implementations. On top of flange plate 220 is a thrust bearing 222, which may, for example, be uncoupled from flange plate 220. Thrust bearing 222 axially supports mounting tube 216 while allowing it to rotate. Thrust bearing 222 may be composed of metal, polymer, or any other appropriate type of material and may have a needle, roller, or other appropriate configuration. Furthermore, thrust bearing 222 may be lubricated or unlubricated.

Mounting tube 216 includes a bearing plate 224 that sits on top of thrust bearing 222. Thrust bearing 222 allows some axial movement between trust bearing 222 and bearing plate 224 at some points of operation. In the illustrated implementation, bearing plate 224 is welded to mounting tube 216, but other fastening techniques may be used in other implementations.

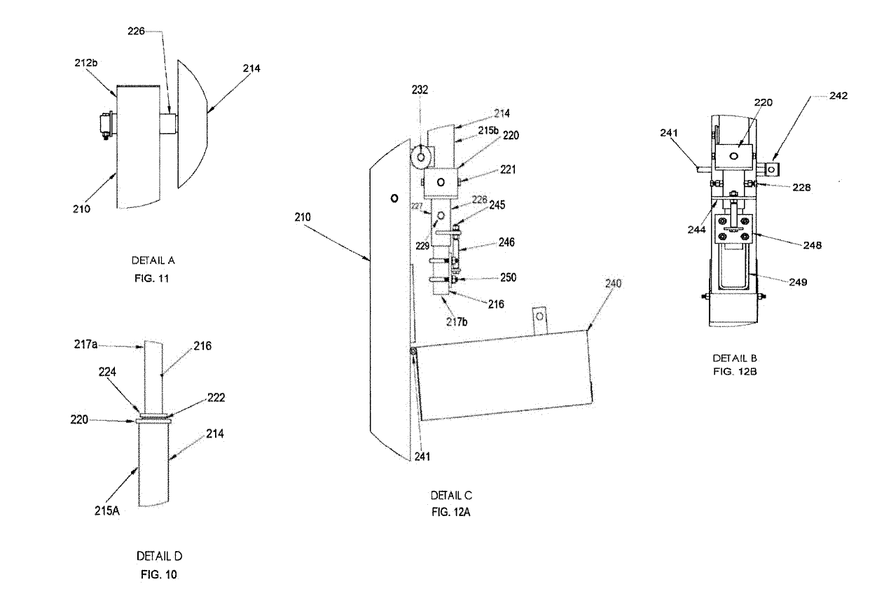

FIG. 11 illustrates the coupling between swing tube 214 and base beam 210. As best seen in this figure, swing tube 214 includes a pivot collar 226 attached thereto. Pivot collar 226 extends through an aperture in base beam 210 (not visible) to allow swing tube 214 to rotate in a vertical plane. Pivot collar 226 may be secured to base beam 210 by various devices (e.g. a bolt, washer, lock washer, and nut combination). Pivot collar 226 may be greased.

FIGS. 12A and 12B illustrate the coupling between near end 215b of tilt tube 214 and base beam 210. As illustrated, tilt tube 214 has a securing tab 232 attached thereto. Base beam also 210 includes a tab (not visible here) that is similar to securing tab 232 so that when securing tab 232 is brought near to the tab on the base beam, the two tabs may be secured together (e.g., by a bolt, washer, lock washer, and nut combination).

Tilt tube 214 also includes a cap 220 mounted onto near end 215b. In the illustrated implementation, the mounting is achieved by bolts 221 that clamp cap 220 onto tilt tube 214 (e.g., through a lock washer). Other fastening techniques (e.g., welding) may be used in other implementations.

Coupled to the bottom of cap 220 is a grasping mechanism 226. Grasping mechanism 226 includes a sleeve 227 and sleeve-mounted set screws 228 (e.g., secured through a nut). Sleeve 227 is coupled to cap 220 (e.g., by welding). Sleeve 227 axially aligns mounting tube 216 while allowing it to rotate about its longitudinal axis. Sleeve 227 includes a number of apertures (not visible in these views) through which set screws 228 may be inserted. Set screws 228 may clamp onto the outer surface of mounting tube 216 to secure it against rotation about its longitudinal axis. The set screws may also prevent mounting tube 216 from translating axially. In the illustrated implementation, sleeve 227 includes two apertures through which set screws may be inserted. In other implementations, a different number of apertures may be used (e.g., three or five). In general, a grasping mechanism may be any that can selectively engage mounting tube 216 to prevent it from rotating.

Sleeve 227 also includes a plate 244 coupled thereto. Plate 244 includes an arcuate slot (not visible here) through which a threaded portion of a handle 246 may pass. Handle 246 may be secured to plate 244 by nuts 245 on either side thereof (possibly in combination with washers). At the other end, handle 246 may be coupled to near end 217b of mounting tube 216 by a bracket 248 secured to the near end by U-bolts 250.

Base beam 110 also includes a cover 240 pivotably mounted thereto at a pivot 241 and an exteriorly reinforced port 249 through which communication cables may be routed. When near end 215b of tilt tube 216 has been secured by securing tab 232, cover 240 may be pivoted over near end 215b so that it at least partially surrounds securing tab 232 and set screw 228, to prevent tampering with mounting tube 216.

In operation, the azimuth of removed end 217a of mounting tube 216, and, by consequence, that of antenna 202, may be adjusted by loosening set screw 228 in sleeve 227 and nuts 244 and grasping and turning handle 242. Because thrust bearing 222 is carrying the weight of mounting tube 216, this adjustment may be performed without the aid of a machine in particular implementations (e.g., by hand). In some implementations, the adjustment may be performed with the assistance of a hand tool (e.g., a vise-grip). The azimuth of removed end 217a may be adjusted to the appropriate angle, and the set screw 228 and nuts 244 may be retightened. Additionally, being able to adjust the azimuth may be useful when servicing the antenna (e.g., when removed end 217a of tilt mounting tube 216 has been pivoted close to the ground).

The components of tower system 200 may be made of a variety of materials. For example, base beam 210, pivot tube 214, and mounting tube 216 may be made of steel, aluminum, carbon fiber, or any other appropriate material. In the illustrated implementation, tower system 200 is approximately 40 ft tall, and pivot 218 is approximately 18 ft off the ground. Different heights of towers, types of components, and ratios between components may be used for different applications, however. Moreover, the thrust bearing may be located at the bottom instead of the top of tilt tube 214 or therebetween, or more than one thrust bearing may be used.

The use of the terms “a” and “an” and “the” and similar referents in the context of describing the invention (especially in the context of the following claims) are to be construed to cover both the singular and the plural, unless otherwise indicated herein or clearly contradicted by context. As used herein, the term “a” includes at least one of an element that “a” precedes, for example, “a device” includes “at least one device.” “Or” means “and/or.” Further, it should further be noted that the terms “first,” “second,” and the like herein do not denote any order, quantity (such that more than one, two, or more than two of an element can be present), or importance, but rather are used to distinguish one element from another. The modifier “about” used in connection with a quantity is inclusive of the stated value and has the meaning dictated by the context (e.g., it includes the degree of error associated with measurement of the particular quantity).

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits, and ranges may appear in one or more claims below. All numerical values are “about” or “approximately” the indicated value, and take into account experimental error and variations that would be expected by a person having ordinary skill in the art. Where such experimental error and expected variations are not determinable according to the person having ordinary skill in the art standard, then “about” or “approximately” numerical values are defined to include a plus or minus 5% of the stated absolute numerical value.

Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R.sub.1, and an upper limit, R.sub.u, is disclosed, any number falling within the range is specifically disclosed. In particular, the following numbers within the range are specifically disclosed: R=R.sub.1+k*(R.sub.u−R.sub.1), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed.

Use of broader terms such as comprises, includes, and having should be understood to provide support for narrower terms such as consisting of, consisting essentially of, and comprised substantially of.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

The invention has been described with reference to particular embodiments, and several others have been mentioned or suggested. Moreover, those skilled the art will readily recognize that a variety of additions, deletions, substitutions, and transformations may be made to the disclosed embodiments while still achieving an azimuth-adjustable tilt tower. Thus, the scope of protection should be judged based on the claims below, which may encompass one or more concepts one or more embodiments. Each and every claim is incorporated as further disclosure into the specification, and the claims are embodiment(s) of the present invention.

1. A tilt-tower system comprising:
an tilt tube having a near end and a removed end;
an elongated mounting tube that extends through and protrudes from the ends of the tilt tube, the mounting tube having a near end and a removed end, the removed end of the mounting tube adapted to allow a communication antenna to be mounted thereto;
a pivot coupled to the tilt tube, the pivot configured to allow the tilt tube to rotate vertically, the vertical rotation moving the removed end of the mounting tube from an upright position to a ground-accessible position; and
a thrust bearing coupled to the removed end of the tilt tube, the thrust bearing axially supporting the mounting tube while allowing it to rotate, wherein the mounting tube may be rotated about its longitudinal axis while the removed end of the tilt tube is in the upright position.

2. The tilt-tower system of claim 1, wherein the tilt tube is at least 80% as long as the mounting tube.

3. The tilt-tower system of claim 1, further comprising a grasping mechanism coupled to the near end of the tilt tube, the grasping mechanism adapted to selectively engage the mounting tube to prevent it from rotating around its longitudinal axis.

4. The tilt-tower system of claim 3, wherein the grasping mechanism includes a sleeve configured to surround the mounting tube.

5. The tilt-tower system of claim 4, wherein the sleeve includes a number of radial apertures that allow a number of screws to penetrate the sleeve and engage the mounting tube.

6. The tilt-tower system of claim 1, further comprising a grasping mechanism coupled to the near end of the mounting tube, the grasping mechanism adapted to selectively engage the mounting tube to prevent it from rotating around its longitudinal axis.

7. The tilt-tower system of claim 1, wherein the thrust bearing is located on top of the tilt tube.

8. The tilt-tower system of claim 1, wherein the mounting tube includes a bearing plate near the removed end, the bearing plate adapted to engage the thrust bearing.

9. The tilt-tower system of claim 8, wherein the thrust bearing allows the mounting tube to move longitudinally relative to the tilt tube.

10. The tilt-tower system of claim 1, wherein the thrust bearing allows the mounting tube to be rotated by hand when the pivot tube is in the upright position.

11. The tilt-tower system of claim 1, further comprising a base beam, the base beam adapted to support the pivot.

12. The tilt-tower system of claim 10, wherein the base beam comprises an elongated cavity, and the near end of the tilt tube is sized to fit at least partially within the cavity.

13. The tilt-tower system of claim 10, further comprising a cover pivotably coupled to the base beam, the cover adapted to surround the near end of the mounting tube when the removed end is in the upright position.

14. The tilt-tower system of claim 1, further comprising a radial bracket coupled to the near end of the mounting tube, the bracket configured to prevent the near end of the mounting tube from sliding into the tilt tube.
